(19) United States
(12) Patent Application Publication
(10) Pub. No.: US 2017/0002999 A1
(43) Pub. Date: Jan. 5, 2017

(54) DISCONTINUOUS ANNULAR REFLECTOR FOR LAMP

(71) Applicant: GE Lighting Solutions, LLC, East Cleveland, OH (US)

(72) Inventors: William Stewart JOHNSON, East Cleveland, OH (US); Benjamin Lee YODER, East Cleveland, OH (US)

(21) Appl. No.: 14/790,035

(22) Filed: Jul. 2, 2015

(51) Int. Cl. F21V 7/04

(52) U.S. Cl. CPC F21V 7/04; F21Y 2101/02

(57) ABSTRACT

According to some embodiments, a light source assembly includes an at least partially transparent or translucent housing; a base plate disposed within the housing, the base plate supporting a plurality of annularly arranged light-emitting units; and a reflector, coupled to the base plate, the reflector having a substantially-annular discontinuous surface, wherein an exterior surface of the reflector is operative to reflect light emitted from the light-emitting units. Numerous other aspects are provided.

### FIELD OF THE INVENTION

Embodiments of the present invention generally relate to light sources using a reflector that reflects light.

### BACKGROUND OF THE INVENTION

Incandescent lamps or light sources commonly provide an illumination pattern in all directions (“omni-directional”). In contrast, light-emitting diodes (LEDs) provide illumination in primarily one direction. Omni-directional LEDs refer to light source products whereby a plurality of LEDs are housed in a bulb or diffuser that may include a reflector, and the LEDs are arranged to provide an illumination pattern in many directions. However, the reflector in conventional omni-directional LEDs may result in a shadow and/or abrupt edge being visible on the housing, which may be undesirable.

Accordingly, the present inventors have recognized that a need exists for an improved, dependable omni-directional light emitting light source.

### SUMMARY OF THE INVENTION

In one embodiment, a light source assembly includes an at least partially transparent or translucent housing; a base plate disposed within the housing, the base plate supporting a plurality of annularly arranged light-emitting units; and a reflector, coupled to the base plate, the reflector having a substantially-annular discontinuous surface, wherein an exterior surface of the reflector is operative to reflect light emitted from the light-emitting units.

In another embodiment a reflector for use in a light source includes a plurality of annular sections, wherein two adjacent annular sections are connected by one or more connectors, and each section is separated from an adjacent section by a gap, wherein the plurality of sections are operative to reflect light.

### BRIEF DESCRIPTION OF THE DRAWINGS

Aspects and/or features of the invention and many of their attendant benefits and/or advantages will become more readily apparent and appreciated by reference to the detailed description when taken in conjunction with the accompanying drawings, which drawings may not be drawn to scale.

FIG. 1 illustrates an omni-directional lamp in a base-up position;

FIG. 2 is a cross-sectional view of an assembled lamp including a reflector in accordance with some embodiments of the disclosure; and

FIGS. 3A and 3B are an enlarged cross-sectional view of a portion of a lamp light reflector having one and two gaps, respectively, according to some embodiments of the disclosure.

### DETAILED DESCRIPTION

Some embodiments may include a light source that includes a reflector having a discontinuous surface. In some embodiments, the reflector may include a plurality of ring-shaped sections with gaps between the sections. Light emitted from light emitting units may be reflected by a reflective ring-shaped surface, and may pass through the gaps between the sections. The combination of reflective surfaces and gaps may reduce the shadow produced by conventional omni-directional light products.

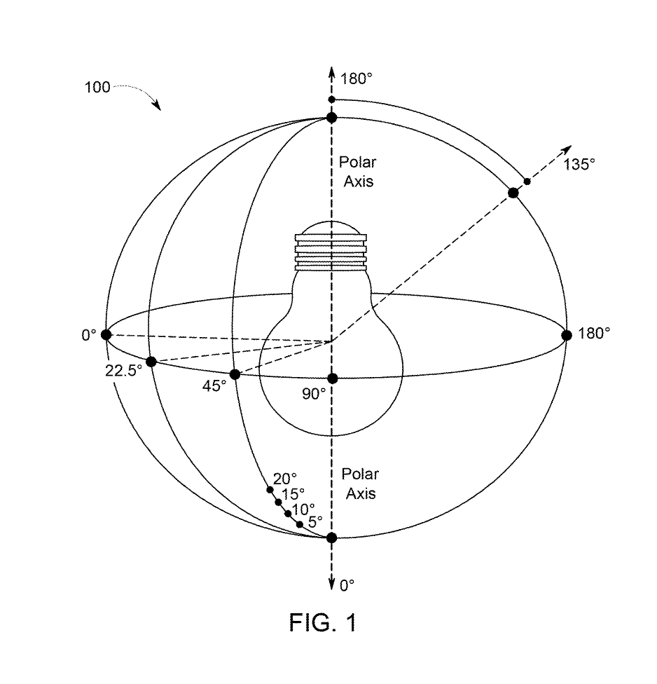

Another consideration addressed by one or more embodiments is energy efficiency. An international standard for energy efficient consumer products is Energy Star^{SM}. Devices carrying the Energy Star mark, such as light sources, have met certain Energy Star requirements and may use 20-30% less energy than required by federal standards. Regarding Energy Star requirements for light sources, and in particular for ENERGY STAR Lamps V1.1, for an omni distribution luminous intensity (candelas (cd)) may be measured within each vertical plane at a 5° vertical angle increment (maximum) from 0° to 135°. The measurements may be repeated in the vertical planes about the lamp (polar) axis in maximum increments of 22.5°, from 0° to 180°. In particular, to qualify for an Energy Star rating, lamp luminous intensity distribution may emulate that of a reference incandescent lamp as follows: 90% of the luminous intensity measured values (candelas) shall vary by no more than 25% from the average of all measured values in all planes; all measured values (candelas) shall vary by no more than 50% from the average of all measured values. Additionally, the light distribution zone may be vertically axially asymmetrical, where at least 5% of the flux (lumens) may be emitted in the 135° to 180° zone, as illustrated by the omni-directional light source 100 in FIG. 1.

To meet Energy Star requirements, conventional omni-directional LEDs typically include a particular ratio of LEDs positioned central to a reflector and around an exterior of the reflector. While some conventional omni-directional LEDs have not included centrally positioned LEDs, to reduce LED counts and thereby reduce costs, for example, the shadow in these light sources may increase and optical efficiency may decrease compared to conventional omni-directional LEDs including interior and exterior LEDs.

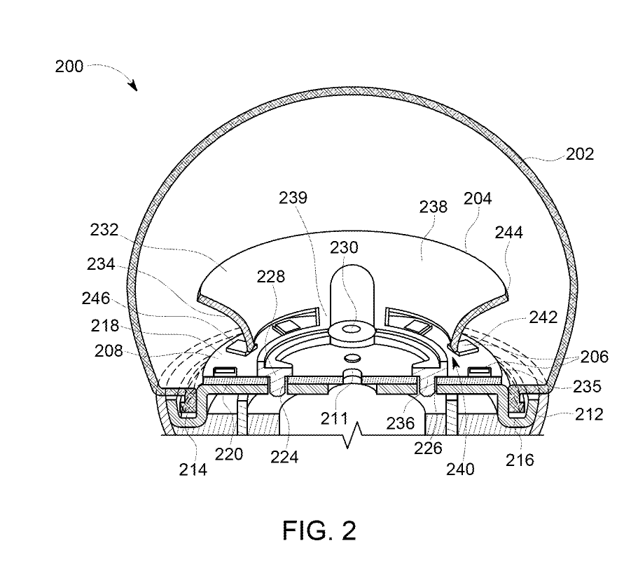

FIG. 2 is a cross-sectional view of an assembled lamp or light source 200 including a housing 202, a reflector 204, a plurality of light emitting units 206 and a base plate 208 according to some embodiments. In one or more embodiments, the light source 200 may qualify for an Energy Star rating.

The housing 202 may be coupled to a lamp base 212. The housing 202 may have an A-line shape, such as that depicted in FIG. 2, or may be any other suitable shape for directing and diffusing light from light emitting units 206. In some embodiments, the housing 202 may be transparent to all light. In some embodiments, the housing 202 may include particles that scatter light with a translucent appearance. An open end 214 of the housing may be selectively coupled to the lamp base 212. While the lamp base 212 shown in FIG. 2 includes a recess 216 to receive a portion of the housing 202, any other suitable coupling methods may be used.

The lamp base 212 may include the base plate 208. While the base plate 208 shown herein is substantially circular-shaped, any other suitable shape may be used. When assembled, the base plate 208 is positioned within the housing 202 of the light source 200. The base plate 208 may be one of coupled to the lamp base 212 (e.g., via a mounting hole (not shown) engageable with a screw or fastener, for example) and integrally formed with the lamp base 212. The base plate 208 may include a central hole 211 that may provide a path for wires to connect a driver to the light emitting units 206, or may provide a space for push-in connectors that may mount to a circuit board. The base plate 208 may include a top surface 218 and bottom surface 220 that are planar and parallel to each other. In one or more embodiments, the plurality of light emitting units 206 may be mounted to the top surface 218 of the base plate 208. The base plate 208 may be a circuit board connected electrically to the light emitting units 206 to provide power to the light emitting units 206. The light emitting units 206 may be light-emitting diodes (LEDs) or any other suitable light source. In one or more embodiments, the light emitting units 206 may be annularly arranged around the base plate 208. In one or more embodiments, the base plate 208 may include a base plate opening 224 that may correspond with a lamp base opening 226. While the base plate opening 224 and lamp base opening 226 are annularly shaped, as shown in FIG. 2, the openings 224, 226 may be any suitable shape.

The reflector 204 may include a reflector base 228. As shown in FIG. 2, the reflector 204 may be selectively coupled to the light source 200 whereby the reflector base 228 may be first received by the base plate opening 224 and then by the lamp base opening 226. In one or more embodiments, the reflector base 228 may be secured in the openings 224, 226 via any suitable securing means (e.g., adhesive, pressure-fit, etc.). In one or more embodiments, the reflector base 228 may include a mounting hole 230. The mounting hole 230 may extend through the reflector base 228. The mounting hole 230 may be configured to provide clearance for a screw or fastener to secure the reflector 204 to the base plate 208. In one or more embodiments, the mounting hole 230 may be configured to engage with a screw or fastener to secure the reflector 204 to the base plate 208. In some embodiments, the reflector 204 may include a groove 231 proximate the mounting hole 230 to allow clearance for a tool to secure the reflector 204 to the base plate 208. In one or more embodiments, the base plate 208 may include a recess instead of the opening 224 to receive the reflector base 228. In one or more embodiments, the reflector 204 may be integrally formed with the base plate 208 or may be secured to the base plate 208 via any suitable securing means (e.g., fastening means, screws, adhesives, etc.).

The reflector 204 may include an interior surface 232 and an exterior surface 234. The interior 232 and exterior 234 surfaces may be reflective and may be made from the same or different materials. In one or more embodiments, the reflector 204 may be made from a reflective material or may be coated with a reflective material. In one or more embodiments, the reflector 204 may be mounted to the base plate 208 such that the light emitting units 206 are arranged circumferentially between an exterior surface 234 of the reflector 204 and an edge 235 of the base plate 208. In one or more embodiments, an arrangement of light emitting units 206 on the base plate 208 within the interior surface 232 of the reflector 204 may be avoided to provide for more efficient thermal usage and reduced heatsink designs, while the reflector 204 provides a reduced shadow compared to conventional omni-directional light sources, as further described below. While the reflector 204 shown herein may be substantially funnel- or annularly-shaped, having a cross-section that gradually decreases in a direction towards the reflector base 228, any suitable shaped reflector may be used.

In one or more embodiments, the reflector 204 may be discontinuous and include a bottom section 236 and one or more upper sections 238, whereby each adjacent section 236, 238 is separated by at least one gap 240. As described further below, the discontinuous aspect of the reflector 204 (e.g., split into two or more sections) may allow precisely targeted or directed light to pass through the gap(s) in the reflector 204. Of note, the precisely targeted light may reduce and/or eliminate the abrupt shadow edge provided with conventional omni-directional LEDs. Additionally, by precisely targeting the light, Energy Star requirements may be met for a variety of light emitting unit distributions, including a distribution with no centrally located light emitting unit. In one or more embodiments, a gap width may be 5% to 20% of the overall height of the reflector 204, but other suitable gap widths may be used. In one or more embodiments, the gap width may be approximately 12% of the overall height of the reflector 204. In one or more embodiments, the gap width may be based on the placement of the light emitting units 206 relative to the exterior surface 234 of the reflector 204. For example, as the distance between the light emitting units 206 and the exterior surface 234 of the reflector 204 increases, the size of the gap may increase such that a suitable amount of light may be precisely targeted to meet Energy Star requirements, for example. In one or more embodiments, the reflector 204 may be formed as a single article and the sections 236, 238 may be formed by removing at least a portion of the reflector 204, such that the sections 236 may be connected to each other via one or more connectors 239, (e.g., the remaining portion of the reflector) integrally formed with the reflector 204. In other embodiments, the sections 236 and 238 may be separately formed and coupled together by one or more connectors 239. The bottom section 236 may be integrally formed with the reflector base 228. In one or more embodiments, the exterior surface of the bottom section 236 may be perpendicular to the top surface 218 of the base plate 208. In one or more embodiments, the exterior surface of the bottom section 236 may be curved. In one or more embodiments, the exterior surface 234 of the upper section 238 may be curved or arc-shaped. In one or more embodiments, the curve of the upper section 238 may extend outward from a bottom edge 242 of the upper section 238 towards a top edge 244 of the upper section 238 such that a circumference of the top edge 244 is greater than a circumference of the bottom edge 242. In one or more embodiments, the curve of the upper section 238 may be such that the top edge 244 of the upper section 238 is vertically aligned with at least one of the base plate edge 235 and an outer edge 246 of the light emitting unit 206 positioned closest to the base plate edge 235, such that at least a portion of the upper section 238 is located over the light emitting unit 206. In one or more embodiments, a point on an outer edge 246 of a light emitting unit 206 is positioned in a plane which is substantially perpendicular to the base plate 208, and wherein at least one section of the reflector 204 intersects that plane.

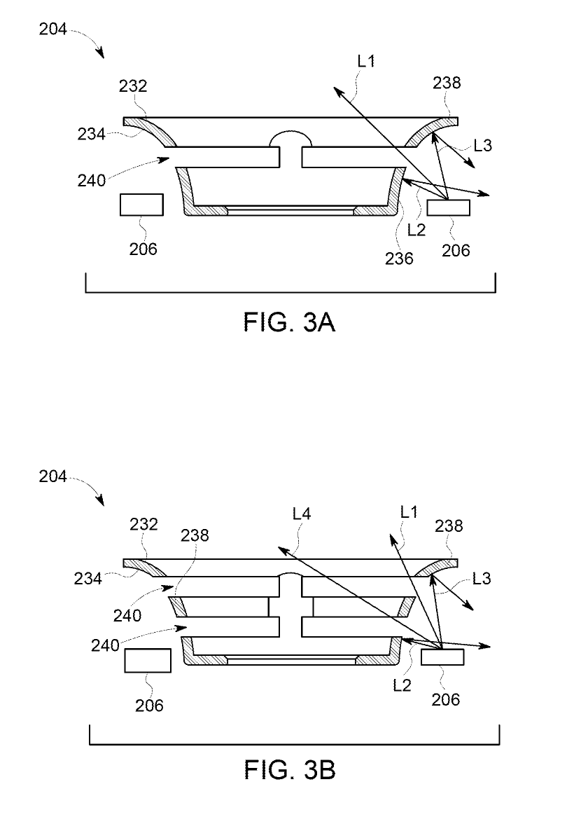

In operation, as the plurality of light emitting units 206 emit light in substantially the same direction, the reflector 204 guides the light emitted by the light emitting units 206, as indicated by the light traveling paths in FIGS. 3A and 3B. Specifically, in both FIGS. 3A and 3B, light ray L2 and L3 emitted from one of the light emitting units 206 are reflected by the reflective surface of the bottom/lower section 236 of the reflector 204 and upper section 238 of the reflector 204, respectively, towards a region of the housing 202 which is closer to the base plate than to the zenith of the housing. In addition to a light ray L1 emitted from the light emitting unit 206 passing through the gap 240, the reflector 204 reflects the incident light rays L2 and L3 to expand the illumination angle. The gaps 240 may provide for the uplight (e.g., light emitted between 18 degrees and 38.5 degrees) to be targeted, as opposed to a fixed central LED output, for example. In one or more embodiments, multiple gaps 240 (FIG. 3B), may provide for additional opportunities to direct the uplight (e.g., L1 and L4), and generally provide better light control. One of the benefits of targeting the uplight is that the light rays may be directed to reduce the appearance of a shadow edge that may otherwise be apparent in gap-less reflectors. As described above, the interior surface 232 of the reflector may be reflective and reflect light incident thereon, in one or more embodiments. For example, in one or more embodiments, a portion of the light that contacts the housing 202 may be reflected and may then contact the interior surface 232 of the reflector 204 and be further reflected. As another example, a portion of the light may directly contact the interior surface 232 of the reflector as it passes through the gap. A benefit of the reflective interior surface 232 of the reflector is that a reflective interior surface 232 may reduce light loss.

The above descriptions and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A light source assembly comprising:
an at least partially transparent or translucent housing;
a base plate disposed within the housing, the base plate supporting a plurality of annularly arranged light-emitting units; and
a reflector, coupled to the base plate, the reflector having a substantially-annular discontinuous surface, wherein an exterior surface of the reflector is operative to reflect light emitted from the light emitting units.

2. The light source of claim 1, wherein the plurality of annularly arranged light emitting units are disposed between an exterior portion of the reflector and an interior of the housing.

3. The light source of claim 1, wherein the reflector includes at least two sections separated by at least one gap.

4. The light source of claim 3, wherein, in operation, at least a portion of light emitted from the light emitting units passes through the at least one gap.

5. The light source of claim 4, wherein the gap is disposed to direct the light between 18 degrees and 38.5 degrees.

6. The light source of claim 3, wherein a point on an outer edge of a light emitting unit is positioned in a plane which is substantially perpendicular to the base plate, and wherein at least one section of the reflector intersects said plane.

7. The light source of claim 1, wherein the reflector is formed as a single article, where the discontinuous surface is formed by removing at least a portion of the reflector.

8. The light source of claim 1, wherein the plurality of light emitting units emit light in substantially the same direction.

9. The light source of claim 1, wherein the reflector is annularly shaped.

10. The light source of claim 1, wherein at least a portion of the surface of the reflector is arc-shaped.

11. The light source of claim 1, wherein an exterior surface of the reflector is configured to reflect light towards a region of the housing which is closer to the base plate than to the zenith of the housing.

12. The light source of claim 1 wherein the reflector is supported by a top surface of the base plate on which the light emitting units are mounted.

13. The light source of claim 1, wherein an interior surface of the reflector is reflective.

14. A reflector for use in a light source, the reflector comprising:
a plurality of annular sections, wherein two adjacent annular sections are connected by one or more connectors, and each section is separated from an adjacent section by a gap, wherein the plurality of sections are operative to reflect light.

15. The reflector of claim 14, wherein a cross-section of a first section is smaller than a cross-section of an adjacent second section.

16. The reflector of claim 14, wherein at least one of an exterior surface and an interior surface of each of the annular sections is operative to reflect light.

17. The reflector of claim 14, wherein the connector is integrally formed with the reflector.

18. The reflector of claim 14, wherein an exterior of at least one of the plurality of sections is arc-shaped.
